(19) United States
(12) Patent Application Publication
(10) Pub. No.: US 2005/0018079 A1
(43) Pub. Date: Jan. 27, 2005

(54) Method of selecting a teletext page, teletex receiver and television set

(76) Inventor: Renatus Josephus Van Der Vleuten, Eindhoven (NL)

Correspondence Address: Philips Electronics North America Corporation;Corporate Patent Counsel, PO Box 3001, Briarcliff Manor, NY, 10510, US

(21) Appl. No.: 10/495,950

(22) PCT Filed: Nov. 22, 2002
(86) PCT No.: PCT/IB02/04954

(30) Foreign Application Priority Data
Nov. 23, 2001 (EP) 01204501.9

(51) Int. Cl. H04N 7/16

(52) U.S. Cl. 348/468; 725/137

(57) ABSTRACT

In a method of selecting a teletext page, a user enters at least a first digit in a desired teletext page number, and a table (33) comprising combinations of a page number and an indication of the probability of the corresponding page being desired is consulted. The table (33) is a histogram of previously selected pages. A complete teletext page number is selected from the table (33) on the basis of the probability indications after part of the desired teletext page number has been entered, and may depend on the currently displayed page. The likelihood information can also be used in page selection with a ‘zap’ button. When this button is pressed, the next most likely page is displayed.

The invention relates to a method of selecting a teletext page, wherein a user enters at least a first digit in a desired teletext page number, and a table comprising combinations of a page number and an indication of the probability of the corresponding page being desired is consulted.

The invention further relates to a teletext receiver, comprising an input responsive to user controls, for entering at least a first digit in a desired teletext page number, memory containing a table of combinations of a page number and an indication of the probability of the corresponding page being desired, and a processor.

The invention further relates to a teletext receiver processor, a computer program and a television set.

Examples of a method, system, teletext receiver processor, program and television set of the kind mentioned above are known. GB-A-2 272 616 discloses a teletext receiver. It comprises a page selection memory for storing information indicative of the relative frequency of user selection of the page identifiers. It also comprises a page memory for storing teletext pages corresponding to the most frequently selected page identifiers. Furthermore, the receiver comprises means responsive to user selection of a page identifier for which the corresponding teletext page is stored in the page memory, for retrieving that teletext page from the page memory for display. A page selector is responsive to user control to output a page number selected by the user, a television channel number selected by the user and a selection signal indicating that a new page or channel selection has been made.

The known receiver does not address the inconveniences experienced by a user when entering a teletext page number. Manual selection of a teletext page number still frequently occurs in normal teletext use. When such a page number is entered, the user has to enter all three digits before the new page is selected and can be displayed. An error during entering of the number means the user has to start entering the number all over again from the start.

It is an object of the invention to provide a method, receiver, processor, program and television set according to the preamble of claims 1, 10, 11, 12, and 13, respectively, that enable a user to select a preferred teletext page in an easy manner.

This object is achieved with the method according to the invention, which is characterised in that a complete teletext page number is selected from the table on the basis of the probability indications after part of the desired teletext page number has been entered.

Thus, the user need press only a limited number of buttons. The table, which comprises the numbers of the pages most likely to be desired by the user, is used to form a complete teletext page number, which can then be displayed. The user has to enter a lesser number of digits, making the whole process of page selection much less prone to user errors.

An embodiment of the method according to the invention is characterised in that a complete teletext page number is selected comprising the entered digits.

If the user enters a ‘1’, then the probability indications of all page numbers in the table starting with the digit ‘1’ are compared, and the most likely one is selected. Again, only a limited number of keys, in this case only one, need be pressed to select the page most likely to be the one desired by the viewer, but the selection is refined. The information entered by the user is taken into account when selecting the complete page number from the table.

An embodiment of the method according to the invention is characterised in that the probability indication is based on a count of the number of times the corresponding page has been selected, and the probability indication is updated after each selection of the corresponding page.

The probability indications are therefore based on the viewing habits of a particular user or group of users. This substantially increases the likelihood that the selected complete page number is in fact the teletext page number desired by the user.

Another embodiment of the method according to the invention is characterised in that the number of a currently selected page is determined, and used as the basis for selecting from the table a complete teletext page number for which the probability indication is dependent on the number of a currently selected page.

Suppose for example, that a particular viewer often switches to page ‘211’ after viewing page ‘100’, but usually switches to page ‘214’ after viewing page ‘213’. If this particular user enters the digit ‘2’ as a first digit for a desired page, the method comprises checking which page he was viewing whilst entering the digit ‘2’. If this was ‘100’, then the ‘2’ will be completed to form ‘211’, if it was ‘213’, the digits ‘1’, ‘4’ will be appended to form ’214′. This embodiment is thus more finely customised to take account of viewer habits.

A further embodiment of the method according to the invention is characterised in that the contents of a currently selected page are determined, and used as the basis for selecting from the table a complete teletext page number for which the probability indication is dependent on the contents of a currently selected page.

For example, if the currently selected page contains weather information, this fact is used to give the probability indications corresponding to the numbers of other weather-related pages extra weight. Thus, additional topical information is used to increase the chance that the selected page number is indeed the number of the desired page.

Another embodiment of the method according to the invention is characterised in that a currently selected channel is determined, and used as the basis for selecting a complete teletext page number from the table for which the probability indication depends on the currently selected television channel.

Thus, account is taken of differing assignments of page numbers for different teletext services. For example, the page containing the weather information in one teletext service might not have the same number as that provided with the teletext service on another channel. Also, the viewer might be accustomed to consulting one teletext service for sports information and a second for the weather information. This embodiment also provides an increased chance that the selected page number is indeed the number of the desired page.

Another embodiment of the invention is characterised in that the teletext page corresponding to the complete teletext page number becomes the current page if no further page selection commands are entered during a certain interval of time.

In this embodiment, the user therefore has time to enter a correction if the selected complete page number is not the desired page. If no the user enters no further commands, for example page number digits, during the interval, it is assumed that the user agrees with the selected page. In most cases, the number of keys pressed thus stays the same.

A further embodiment of the method according to the invention is characterised in that, upon an indication that the complete teletext page number is not the desired teletext page number, a second complete teletext page number is selected from the table on the basis of the probability indications.

Thus, the method does not have to be entirely repeated if the first selected complete page number is not the desired page number.

Another embodiment of the method according to the invention is characterised in that a plurality of further complete teletext page numbers are selected from the table on the basis of the probability indications, and the selected page numbers are presented to the user to choose from.

Thus, the number of keys to be pressed is still limited, and the selection process is still made much user-friendlier. Account is, however, also taken of the fact that the page number determined to be the most likely to be desired in general, might under certain circumstances not actually be the desired page number.

The teletext receiver according to the invention is characterised in that the receiver has an auto-complete function, comprising selection of a complete teletext page number from the table after part of the desired teletext page number has been entered.

Thus, the method according to the invention is implemented as a function in a teletext receiver. Such receivers are known as such. They can be comprised in television sets, video recorders, set-top boxes, or TV-cards for computers, for example. The method according to the invention is therefore an extension of the range of features that can be provided with such devices, requiring no specialised hardware.

The teletext receiver processor according to the invention is adapted for carrying out a method according to any one of claims 1-9.

Thus, the teletext receiver allows the automatic execution of the method according to the invention.

The computer program according to the invention is loadable onto a programmable processor, so that the programmable processor programmed in this way is capable of or adapted to carrying out a method according to any one of claims 1-9.

Thus, the invention can be implemented as embedded software in a programmable teletext receiver processor.

The television set according to the invention comprises a teletext receiver according to any one of claims 1-9.

Thus, the invention can be incorporated in a television set with teletext functionality. Cumbersome and annoying fumbling with a remote control unit is not necessary with such a television set, since only one or two keys need be pressed.

The invention will now be explained in further detail, with reference to the enclosed drawings.

FIG. 1 shows a television set and remote control in which the method according to the invention has been implemented.

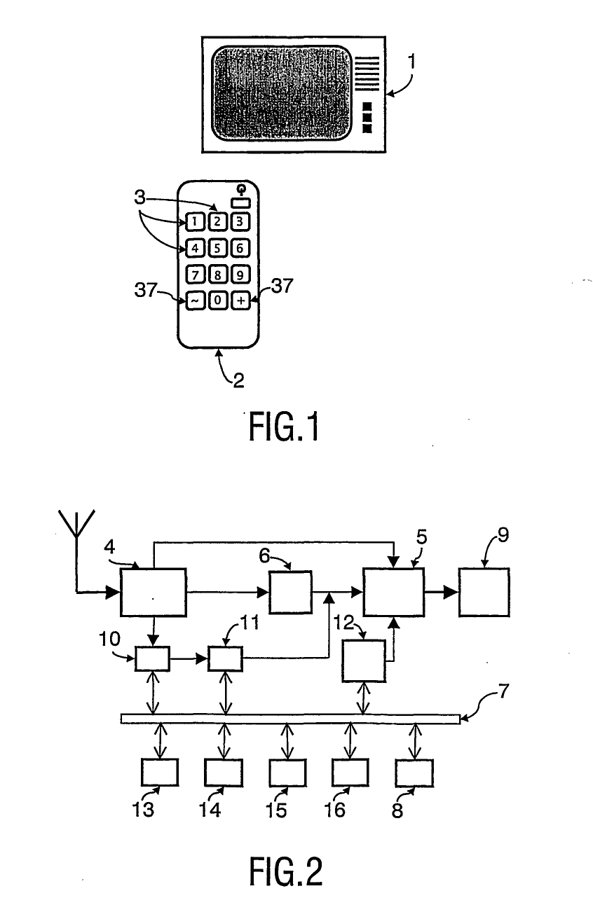

FIG. 2 shows in a very schematic way, an arrangement of several key components of a television receiver arrangement suitable for use with the invention.

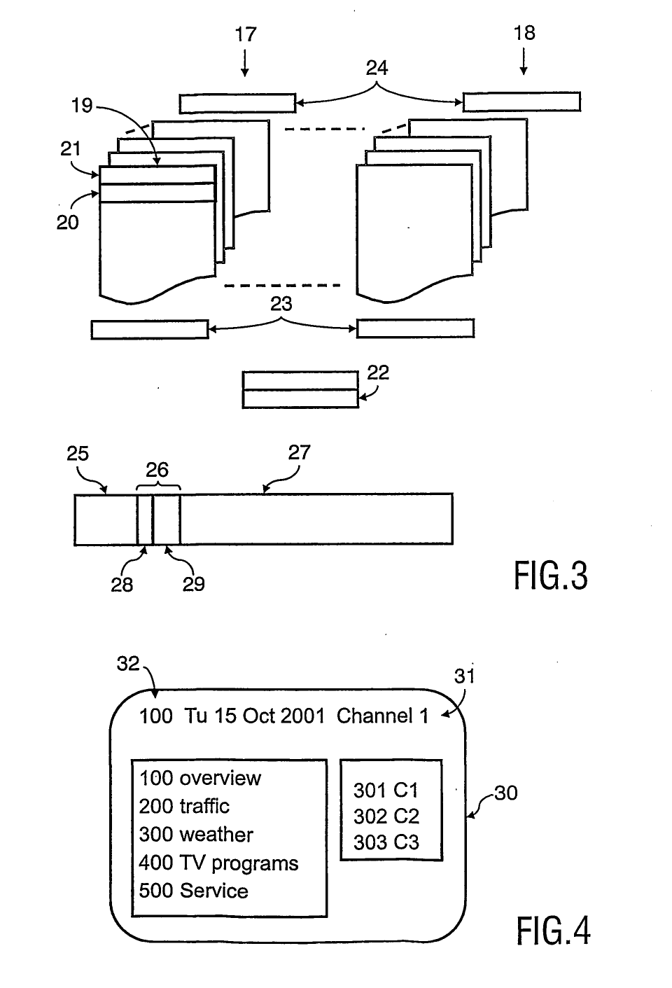

FIG. 3 shows in a very schematic way the composition of a teletext service conform European standard ETS 300 706.

FIG. 4 shows in a very schematic way an example of a teletext page.

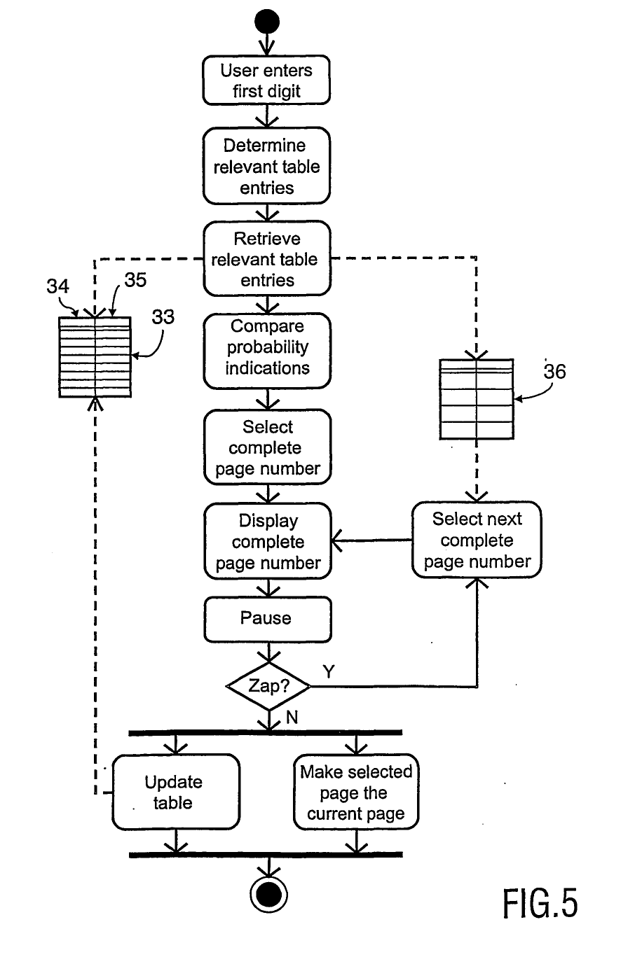

FIG. 5 shows in a very schematic way a flow chart of an embodiment of the method according to the invention.

A television set 1 according to the invention is provided with a teletext decoding function. A user can issue commands to the television set 1 using a remote control unit 2. The remote control unit 2 comprises numerical keys 3, for entering digits. When the television is in the normal viewing mode, the keys 3 are used to switch channels. When the teletext feature is switched on, the numerical keys 3 are used to enter digits making up a teletext page number.

Teletext services are provided to the television set 1 on certain or all of the channels it can received. The invention is not limited to particular teletext or TV formats, as is illustrated in FIG. 2, where some components of a television receiver arrangement are depicted in a diagram. The television receiver arrangement may be part of the television set 1, or it may be comprised in a set-top box connected to a television, be part of a TV card for use in a computer, or be incorporated in a video recorder, for example.

In order to emphasise the fact that the invention is not limited to analogue TV formats, the television receiver arrangement of FIG. 2 also comprises components normally found in a digital television receiver.

Television signals are provided to a network interface 4. These television signals can be provided by way of a cable connection, terrestrial broadcast, or satellite broadcast. They can be in analogue or digital form. The invention is suitable for use with any of the current TV formats, for example DVB formats, PAL and NTSC. Depending on the broadcast method and TV formats that can be received, the network interface 4 will comprise components for tuning and demodulation.

If only analogue TV can be received, the network interface 4 provides an analogue video signal to a video selector 5, and separates the teletext signal from the demodulated television signal. The teletext signal is found in either the virtual blanking interval, in case of interlaced TV formats, or in separate data lines, for non-interlaced formats. A teletext decoder 6 decodes the information.

Commands, such as page selection commands, are provided to the teletext decoder 6 and the interface 4 by means of a bus 7, and user controls 8. The user controls 8 of the television set 1 comprise the remote control unit 2 and an interface thereto, connected to the bus 7, for instance. Other variants of user controls are possible within the scope of the invention.

Examples of bus standards found in television receivers are IIC and PCI. The video selector 5 is also connected to the bus 7, so that the user controls 8 can be used to switch between normal television viewing and teletext. When normal television viewing has been selected, the video selector 5 provides the analogue video signal to a video driver 9, which provides an output signal suitable for display, for example on the screen of the television set 1. When teletext pages are to be shown, the output of the teletext decoder 6 is provided to the video driver 9.

Digital television is received by using a conditional access module 10 and demultiplexing and decoding unit 11 to descramble, decompress, and/or decode the digital broadcast signal, after it has been demodulated. The configuration of FIG. 2 further comprises a graphics processor 12, which can be used for displaying still images and text, such as an on-screen display, electronic program guide, or teletext pages provided with the digital broadcast signal. FIG. 2 further shows a central processing unit 13 (CPU), random access memory 14, volatile read-only memory 15, and system read-only memory 16, all connected to the bus 7.

It will be apparent that various other configurations with only a sub-set of the components of FIG. 2 can be used to implement the invention. Also, the components need not physically be discreet components, but can be integrated on a single IC, or on a limited number of ICs. More than one bus can be present.

Where reference is made to a teletext receiver in this application, any device or arrangement of devices providing full teletext signal processing capability is meant. The term processor is used to refer to the device or arrangement of devices executing the actual instructions. Thus, a teletext receiver can be the teletext decoder 6, a discrete component, if it is provided with the necessary memory and processing capacity. It can also be the whole arrangement of FIG. 2, with teletext processing capability being provided by way of a set of instructions for the CPU, stored, for example in ROM 16, or by way of a set of instruction for the graphics processor 12, or the demultiplexing and decoding unit 11.

The composition of a teletext service conform standard ETS 300 706 of the European Broadcasting Union, is shown schematically in FIG. 2.

The teletext service comprises a number of magazines 17, 18, up to a maximum of eight. Each magazine 17, 18 in turn comprises a number of pages 19. Each page 19 is encoded in packets 20, including a header packet 21. Further packets, which are not part of the pages 19 are also used. Broadcast service data packets 22 define properties for the whole teletext service. Magazine related data packets 23 define properties for all the pages 19 in a magazine 17, 18. Time filling headers 24 are used to signal the end of the last page 19 in a magazine 17, 18.

Each data packet 20 comprises a synchronisation sequence 25, a packet address 26 and data 27. The packet address 26 in this example consists of a magazine number 28 and a packet number 29. The packet number 29 indicates the kind of packet concerned. For example, each header packet 21 has packet number 29 zero. From this value of the packet number 29, the teletext receiver knows that the data 27 of the packet comprises the page address, which is provided with the header packet 21, but not with all the other packets. The page address corresponds to the page number. It is comprised in the first eight bytes of data 27 contained in each packet 20 having a packet number 29 of value zero.

Values one to twenty-four are reserved as packet number 29 for displayable packets, in which the data 27 consists of data displayable in a teletext page. Packets with a value for the packet number 29 between twenty-five and twenty-eight are designated as extension packets.

The teletext receiver receives the data packets 20, and uses them to construct a screen image 30 of a teletext page 19. A header area 31 contains a page number field 32, showing the three-digit number of the currently selected and displayed page 19.

According to the invention, the teletext receiver comprises an auto-complete function, programmed as a set of instructions to be executed by the teletext processor. A user desiring to select a different page 19 for display enters at least a first digit in the desired teletext page number, using the numerical keys 3 of the remote control unit 2 or any other implementation of the user controls 8. This digit is relayed to the teletext receiver. Due to the auto-complete function, it is not necessary to enter all the digits forming the desired page number. The teletext receiver is able to select a complete page number after only a part of the desired page number has been entered.

The teletext receiver has access to a table 33, symbolically depicted in FIG. 5. The table 33 comprises combinations of a page number, in a first column 34, and an indication of the probability of the corresponding page being desired, in a second column 35.

As will be apparent from the description of the television receiver arrangement of FIG. 2, the table 33 can be stored in RAM 14, in memory comprised in the teletext receiver 6, the graphics processor 12, or the demultiplexing and decoding unit 11. This depends on the particular hardware configuration chosen to implement the invention.

Relevant table entries, forming a sub-set 36 of the table 33 are first determined, according to criteria to be further detailed below. These entries are retrieved and the probability indications of the entries in the sub-set 36 are compared. On the basis of the probability indications the complete page number most likely to be the number of the desired page is selected.

The probability indication is preferably based on a count of the number of times the corresponding page 19 has been selected, and is updated after each selection of the corresponding page 19. Thus, the teletext receiver ‘learns’ the habits of the users and is gradually customised. To start, the probability indications can be based on general viewing habits, provided as factory settings or with the teletext service

Several criteria can be applied within the scope of the invention to determine which table entries are relevant.

Preferably, entries for complete teletext page numbers are retrieved that comprise the entered digit(s). For example, if the user has keyed in a ‘1’, then the sub-set 36 will comprise the entries for complete teletext page numbers ‘1—’. Thus the user makes a pre-selection, but does not have to key in the entire number of the desired page 19. Of course, it is also conceivable that the user enters the first two digits of a three-digit page number. This narrows the range of the pre-selection, whilst retaining the advantage of less cumbersome selection, all be it to a reduced extent.

As a further enhancement, the number of a currently selected page 19 is determined, and used as the basis for selecting from the table 33 a complete teletext page number for which the probability indication is dependent on the number of a currently selected page 19.

In this embodiment of the invention, the table 33 will have an appearance similar to the following: Complete page number currently selected page n

| Complete page number | currently selected page | n |
|---|---|---|
| 112 | 100 | 12 |
| | 200 | 4 |
| | 210 | 18 |
| | 214 | 20 |
| 113 | 100 | 6 |
| | 112 | 30 |
| | 200 | 5 |

If the currently selected page, i.e. the page indicated in the page number field 32 of the current screen image 30, is ‘100’, then the relevant table entries are those for which the currently selected page is ‘100’. This means that the complete page number ‘112’ will be selected, since n, the number of times the complete page number has been selected starting from page ‘100’, is greater for page ‘112’ than for page ‘113’. Conversely, if the currently selected page number is ‘200’, then page number ‘1113’ will be selected.

In a further preferred embodiment, the contents of the currently selected and displayed page are determined, and used as the basis for selecting from the table 33 a complete teletext page number for which the probability indication is dependent on the contents of a currently selected page.

Thus, the sub-set 36 will comprise entries that are related in topic to the page 19 currently being displayed, or at least entries that follow logically from the current page.

The contents of the currently selected page can be determined in several ways. A simple way is to use a set of rules classifying the contents on the basis of the page number or magazine number 28, and stored in memory available to the teletext receiver. Alternatively, information comprised in the extension packets can be used to determine the contents of a page 19. As an example, the information provided as part of the Table-of-Pages system (TOP), can be used, or links between pages 19, provided with extension packets X/27.

Another good criterion for determining relevant entries in the table 33, is the currently selected channel. In this embodiment, the probability indication in the table 33 will depend on the currently selected television channel. An excerpt from the table 33 will look like this:

| Complete page number | Currently selected channel | n |
|---|---|---|
| 112 | C1 | 12 |
| | C2 | 4 |
| | C3 | 18 |
| | C4 | 20 |
| 113 | C1 | 6 |
| | C2 | 30 |
| | C3 | 5 |

If the current channel is channel one, then the corresponding values of n will be compared, resulting in page ‘112’ being selected before page ‘113’. Conversely, if the current channel is channel two, then page ‘113’ will be selected.

Once a complete page number has been selected on the basis of the probability indications, the selected page can be made the current page, and its screen image 30 provided.

In a preferred embodiment, the teletext page 19 corresponding to the complete teletext page number becomes the current page if no further page selection commands are entered during a certain interval of time. To this end, the teletext receiver will make use of a timer to count down to the end of the interval. Meanwhile, the selected complete page number can be shown in the screen image 30 instead of the number of the current page in the page number field 32, or elsewhere on the page. The user can thus determine whether the selected page number corresponds to the desired page number. If it does, then the user need take no action, and the page with the selected complete page number will become the current page after the time interval has elapsed.

If the displayed complete page number is not the desired page number, the user can issue further page selection commands within the time interval. Thus, by providing an indication that the complete teletext page number selected is not the desired teletext page number, the user can ensure that a second complete teletext page number is selected from the table 33 or sub-set 36 of the table 33, on the basis of the probability indications.

In the embodiment of FIG. 5, a ‘zap’ key is used. This can be a dedicated function key 37 on the remote control unit 2. Alternatively, one of the numerical keys 3 can have a dual purpose. It is also conceivable that the user enters a further digit of the desired page number, in which case a new sub-set 36 of relevant table entries can be determined and retrieved, on the basis of the second digit.

A good alternative to the embodiment of FIG. 5 is an embodiment wherein a plurality of further complete teletext page numbers are selected from the table 33 on the basis of the probability indications, and the selected page numbers are presented to the user to choose from. For example, the five most likely page numbers of the sub-set 36 can be shown in a list, or in succession in the page number field 32. A dedicated function key 37 or one of the numerical keys 3 can be used to halt the succession of complete page numbers at the desired number. If the numbers are shown in a list, then a cursor and cursor control means will be provided as part of the invention, in order to allow selection of a complete page number from the list.

It will be obvious to those skilled in the art, that the invention is not limited to the embodiments described above, which can be varied in a number of ways within the scope of the claims. In particular, the various criteria for determining relevant table entries are not mutually exclusive, but merely described separately to improve the clarity of description. It is, for example, advantageous to use both the currently selected channel and the number of the currently selected page as a basis for selecting a complete teletext page number from the table. The table in such an embodiment would have a suitable structure. In addition, it is not a necessary aspect of the invention that the distribution of entries over columns and rows in the table be precisely as disclosed.

The invention is summarised as follows. In a method of selecting a teletext page, a user enters at least a first digit in a desired teletext page number, and a table (33) comprising combinations of a page number and an indication of the probability of the corresponding page being desired is consulted. The table (33) is a histogram of previously selected pages. A complete teletext page number is selected from the table (33) on the basis of the probability indications after part of the desired teletext page number has been entered, and may depend on the currently displayed page. The likelihood information can also be used in page selection with a ‘zap’ button. When this button is pressed, the next most likely page is displayed.

1. Method of selecting a teletext page (19), wherein a user enters at least a first digit in a desired teletext page number, and a table (33) comprising combinations of a page number and an indication of the probability of the corresponding page (19) being desired is consulted, characterised in that a complete teletext page number is selected from the table (33) on the basis of the probability indications, after part of the desired teletext page number has been entered.

2. Method according to claim 1, characterised in that a complete teletext page number is selected comprising the entered digits.

3. Method according to claim 1, characterised in that the probability indication is based on a count of the number of times the corresponding page (19) has been selected, and the probability indication is updated after each selection of the corresponding page (19).

4. Method according to claim 1, characterised in that the number of a currently selected page (19) is determined, and used as the basis for selecting from the table (33) a complete teletext page number for which the probability indication is dependent on the number of a currently selected page (19).

5. Method according to claim 1, characterised in that the contents of a currently selected page (19) are determined, and used as the basis for selecting from the table (33) a complete teletext page number for which the probability indication is dependent on the contents of a currently selected page (19).

6. Method according to claim 1, characterised in that a currently selected channel is determined, and used as the basis for selecting a complete teletext page number from the table (33) for which the probability indication depends on the currently selected television channel.

7. Method according to claim 1, characterised in that the teletext page (19) corresponding to the complete teletext page number becomes the current page (19) if no further page selection commands are entered during a certain interval of time.

8. Method according to claim 1, characterised in that upon an indication that the complete teletext page number is not the desired teletext page number, a second complete teletext page number is selected from the table (33) on the basis of the probability indications.

9. Method according to claim 1, characterised in that a plurality of further complete teletext page numbers are selected from the table (33) on the basis of the probability indications, and the selected page numbers are presented to the user to choose from.

10. Teletext receiver, comprising an input responsive to user controls (2; 8), for entering at least a first digit in a desired teletext page number, memory (14, 15) containing a table (33) of combinations of a page number and an indication of the probability of the corresponding page (19) being desired, and a processor (6, 11, 12, 13) characterised in that the receiver has an auto-complete function, comprising selection of a complete teletext page number from the table (33) after part of the desired teletext page number has been entered.

11. Teletext receiver processor adapted for carrying out a method according to claim 1.

12. Computer program loadable onto a programmable processor (6, 11, 12, 13), so that the programmable processor (6, 11, 12, 13) programmed in this way is capable of or adapted to carrying out a method according to claim 1.

13. Television set (1), comprising a teletext receiver according to claim 1.
